(19) United States
(12) Patent Application Publication
(10) Pub. No.: US 2018/0157055 A1
(43) Pub. Date: Jun. 7, 2018

(54) THREE-DIMENSIONAL DISPLAY DEVICE

(71) Applicant: InnoLux Corporation, Miao-Li County (TW)

(72) Inventors: Naoki SUMI, Miao-Li County (TW); Pei-Hsuan CHIANG, Miao-Li County (TW)

(21) Appl. No.: 15/368,851

(22) Filed: Dec. 5, 2016

(51) Int. Cl. G02B 27/22; H04N 13/04

(52) U.S. Cl. CPC G02B 27/2214; G02B 27/225; H04N 13/0404; H04N 13/0409; H04N 13/0415

(57) ABSTRACT

A three-dimensional display device includes a display panel and a plurality of elongate optical elements overlying the display panel. The display panel includes a plurality of subpixels arranged in rows and columns. At least one of the subpixels has a subpixel width along a row direction of the rows of the subpixel. At least one of the elongate optical elements is slanted at a slant angle to a column direction of the subpixel columns and has a pitch along the row direction, wherein the slant angle is 20 to 30 degrees.

### BACKGROUND OF THE INVENTION

### 1. Field of the Invention

The present disclosure relates to a three-dimensional display device and, more particularly, to an auto-stereoscopic three-dimensional display device.

### 2. Description of Related Art

With the advance of technology, the display device is able to not only display a two-dimensional (2D) image, but also a three-dimensional (3D) image. The existent 3D display devices are typically glasses-type 3D display devices, which filter out a part of an image by the glasses, so that the left eye will see the image suitable for left eye viewing and the right eye will see the image suitable for right eye viewing, thereby enabling the human brain to determine the viewed images to be a 3D image. It is uncomfortable to wear a pair of 3D glasses.

In order to watch a 3D image more naturally, there are auto-stereoscopic display devices developed in the market, which are also known as naked-eye 3D display devices or glassless 3D display devices. An autostereoscopic 3D display device can produce a 3D image by controlling the propagation of light at the end of the display panel without the use of 3D glasses. However, an autostereoscopic 3D display device has encountered a drawback in having a significant loss of the display resolution and having Moiré effect. Therefore, it is desirable to provide a novel autostereoscopic 3D display device.

### SUMMARY OF THE INVENTION

The present disclosure provides a three-dimensional display device, including a display panel and a plurality of elongate optical elements overlying the display panel. The display panel includes a plurality of subpixels arranged in rows and columns. At least one of the subpixels has a subpixel width along a row direction of the rows of the subpixels. At least one of the elongate optical elements is slanted at a slant angle to a column direction of the subpixel columns and has a pitch along the row direction, wherein the slant angle is 20 to 30 degrees.

### BRIEF DESCRIPTION OF THE DRAWINGS

For one skilled in the art of the present disclosure to understand the features and the effects of the present disclosure, some embodiments according to the present disclosure will now be described, by way of example, with reference to the accompanying drawings, in which:

FIG. 1 is a schematic diagram showing the structure of the 3D display device (using lens) according to one embodiment of the present disclosure;

FIG. 2 is a schematic diagram showing the configuration of the elongate optical elements according to one embodiment of the present disclosure;

FIG. 3 is a schematic diagram showing the structure of the LC GRIN lenses according to one embodiment of the present disclosure;

FIG. 4 is a graph showing the relationship between the 3D horizontal resolution and the pitch of the elongate optical element according to one embodiment of the present disclosure;

FIG. 5 is a graph showing the relationship between the 3D vertical resolution and the slant angle of the elongate optical element according to one embodiment of the present disclosure;

FIG. 6 is a diagram showing the structure of the 3D display device (using parallax barrier) according to one embodiment of the present disclosure;

FIG. 7 is a schematic diagram showing the structure of the LC parallax barrier according to one embodiment of the present disclosure; and

FIG. 8 is a diagram showing the structure of the 3D display device (using parallax barrier) according to one embodiment of the present disclosure.

### DETAILED DESCRIPTION

The details in in the following embodiments can be modified, varied or altered within the spirit of the present disclosure for different aspects and applications.

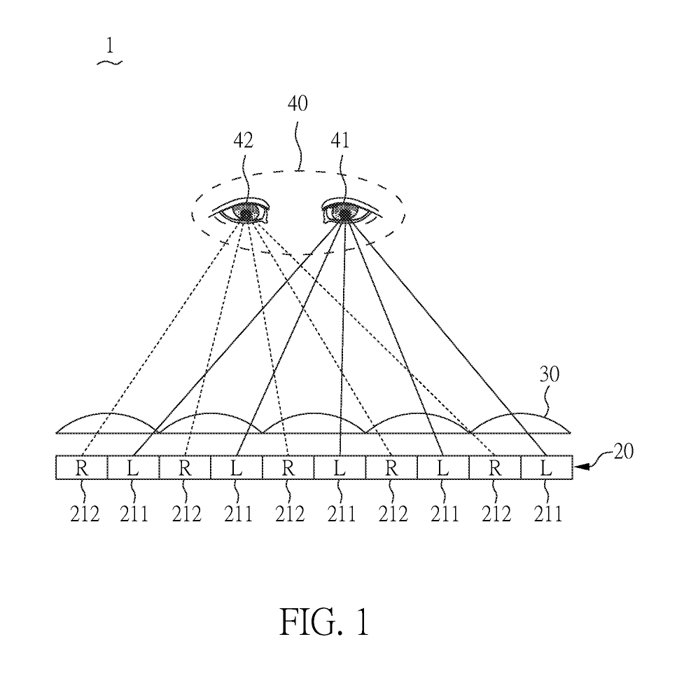

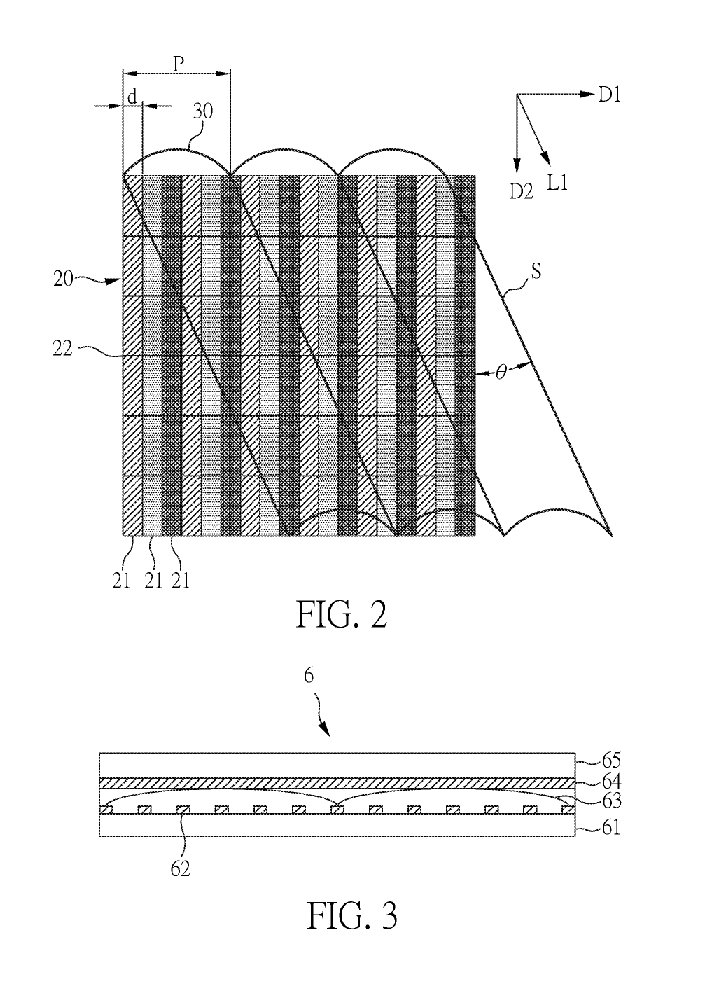

FIG. 1 is a schematic diagram showing the structure of the 3D display device 1 according to one embodiment of the present disclosure, and FIG. 2 is a schematic diagram showing the configuration of the elongate optical elements 30 according to one embodiment of the present disclosure.

As shown in FIG. 1, in this embodiment, the 3D display device 1 mainly includes a display panel 20 and a plurality of elongate optical elements 30. The elongate optical elements 30 overlie the display panel 20. The elongate optical elements 30 can be arranged in front of or behind the display panel 20. The elongate optical elements 30 can be arranged between a user 40 and the display panel 20. Through the elongate optical elements 30, the subpixels of the display panel 20 can be viewed. FIG. 1 shows that the elongate optical elements 30 are arranged in front of the display panel 20.

The display panel 20 can be such a display panel including a plurality of red, green and blue subpixels. For example, the display panel 20 can be a liquid crystal display (LCD) panel, an organic light emitting diode (OLED) display panel, or a micro light emitting diode display panel. The display panel 20 can be an ultra-high resolution panel with a resolution of 4K2K, for example, 3840×2160 pixels, wherein a pixel is composed of three subpixels, generally of red, green and blue colors. The subpixels of the same color can be arranged in a strip pattern or a zigzag pattern.

In view of the structure as shown in FIG. 2, the subpixels 21 of the display panel 20 are arranged in rows and columns. D1 represents the row direction and D2 represents the column direction. The row direction D1 and the column direction D2 are different, and can be, for example, perpendicular to each other.

According to some embodiments, at least one of the subpixels 21 has a subpixel width d along the row direction D1. According to some embodiments, at least a portion of the subpixels 21 can have the same subpixel width. According to some embodiments, each of the subpixels 21 can have the same subpixel width d.

As shown in FIG. 1, the subpixels 21 are divided into a left-eye subpixel group 211 and a right-eye subpixel group 212. The left-eye subpixel group 211 displays a left-eye image L, which is adapted for watching by left eye 41 of the user 40. The right-eye subpixel group 212 displays a right-eye image R, which is adapted for watching by right eye 42 of the user 40. There is a parallax between the left-eye image L and the right-eye image R. Based on the parallax, the human brain will sense the depth of the image, and will perceive the combination of the left-eye image L and the right-eye image R to be a 3D image.

The elongate optical elements 30 can be made of the same material and formed integrally with the same structure. According to some embodiments, at least one of the elongate optical elements is slanted at a slant angle θ to the column direction D2 and has a pitch P along the row direction D1. According to some embodiments, the elongate optical elements 30 can extend along the same direction and can be parallel to each other. In such structure, each of the elongate optical elements 30 is slanted at the slant angle θ to the column direction D2. In FIG. 2, the elongate optical elements 30 extend along a longitudinal axis L1. One of the elongate optical elements 30 has a sidewall S along the longitudinal axis L1. The slant angle θ can be the angle between the column direction D2 and the sidewall S. In other embodiments, the slant angle θ can be the angle between the column direction D2 and the longitudinal axis L1. Each of the elongate optical elements 30 can have the same pitch P and can be slanted at the same slant angle θ.

In some embodiments, the elongate optical elements 30 can be lenses, for example, lenticular lenses or gradient index (GRIN) lenses, for example, liquid crystal gradient index (LC GRIN) lenses. The refractive index of the lens can be 1.5 to 1.7, and the focal length can be adjusted to the gap distance between the display panel 20 and the elongate optical elements 30. The lenses can refract the light to control the propagation of light.

FIG. 3 is a schematic diagram showing the structure of the LC GRIN lenses according to one embodiment of the present disclosure. As shown in FIG. 3, the LC GRIN lenses 6 include a bottom insulant layer 61, a plurality of bottom electrodes 62, liquid crystal 63, a top electrode 64 and a top insulant layer 65, from bottom to top. The profile of the liquid crystal 63 can be changed by applying different voltages to the bottom electrodes 62, so as to form the GRIN lenses.

The number of views is used to represent how many views a 3D display device provides. By using the configuration of the elongate optical elements, the number of views of the 3D display device 1 of the present disclosure can be 10 to 50, for example 15 to 40, for example, 25 to 40, for example, 32.

Conventionally, using elongate optical elements may cause resolution reduction. In some embodiments, the slanted elongate optical elements can more uniformly distribute the resolution reduction of the 3D display device into the horizontal resolution and the vertical resolution. Since the horizontal resolution does not need to bear all of the resolution reduction, the horizontal resolution is relatively increased. Even though the vertical resolution needs to bear a part of the resolution reduction, it has limited influence to the view as long as it is within a tolerable level.

In the present disclosure, the design parameters of the elongate optical elements 30 include the pitch P and the slant angle θ of the elongate optical elements. The criteria to evaluate the parameters include the resolution and Moiré period of the 3D image. In some embodiments, the present disclosure first estimates the pitch P of the elongate optical element 30 according to the depth of the 3D image; then, it estimates the slant angle θ of the elongate optical element 30 according to the depth and the crosstalk of 3D image; finally, it finds the optimized range of pitch P and slant angle θ according to Moiré period.

In the present disclosure, the resolution and the Moiré period of a 3D image can be derived by optical simulations. In the optical simulations, at first, the display panel and the elongate optical elements are set up; then, test images are shown on the display panel; finally a Fourier analysis in the frequency domain is performed with respect to the 3D image shown on the display.

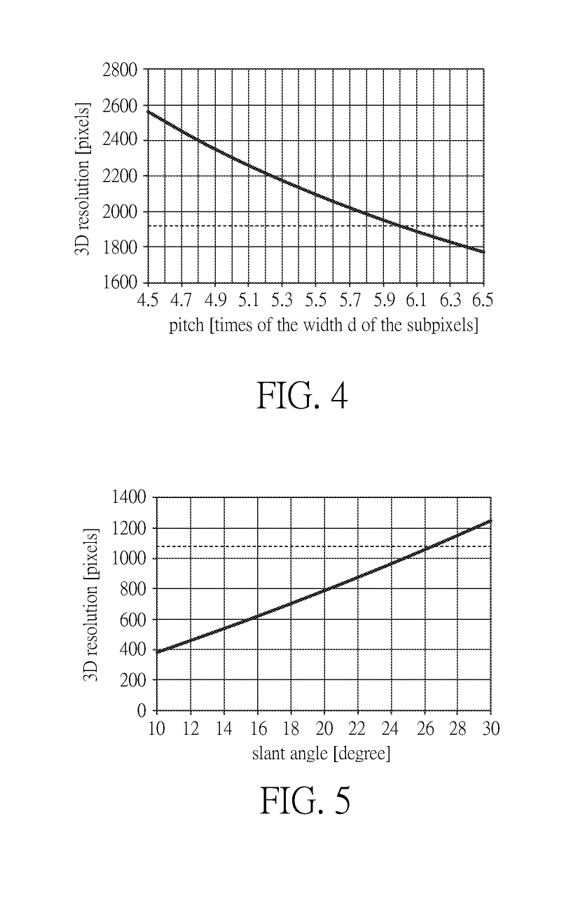

FIG. 4 is a graph showing the relationship between the 3D horizontal resolution and the pitch of the elongate optical element according to one embodiment of the present disclosure. According to some embodiments, a 3D display device having an equivalent resolution of 1920×1080 pixels is taken as a target resolution. The resolution of 1920 pixels is set to be the target of the 3D horizontal resolution, and the pitch size of the elongate optical elements can be chosen to be 4.5 to 5.9 times the subpixel width d according to the graph. According to some embodiments, the pitch size can be 4.8 to 5.6 times the subpixel width d. According to some embodiments, the pitch size can be a multiple times the subpixel width d, in which the multiple can be not an integer 5.

FIG. 5 is a graph showing the relationship between the 3D vertical resolution and the slant angle θ of the elongate optical element according to one embodiment of the present disclosure. According to some embodiments, a 3D display device having an equivalent resolution of 1920×1080 pixels is take as a target resolution. The resolution of 1080 pixels is set to be the target of the 3D vertical resolution, and the slant angle θ can be chosen to be 20 to 30 degrees according to the graph. According to some embodiments, the slant angle θ can be 24 to 30 degrees.

According to some embodiments, when the elongate optical elements included in the 3D display device have the slant angle θ in the above range, the pitch size can be a multiple times the subpixel width d, in which the multiple can be not an integer.

In some embodiments, the pitch and the slant angle θ of the elongate optical elements can be further optimized according to simulation of moiré period. The Moiré period is the occurrence period of a Moiré pattern. Moiré pattern is less perceptible for shorter Moiré period.

Furthermore, the moiré period shorter than 10 to 15 times the subpixel width d occurs in the following conditions. According to some embodiments, the simulation result shows that shorter Moiré period occurs for the elongate optical element models in which the slant angle θ is in the range of 24 to 26 degrees and the pitch P is in the range of 4.8 to 5.5 times the subpixel width d. According to some embodiments, the simulation result also shows that shorter Moiré period occurs for the elongate optical element models in which the slant angle θ is in the range of 28 to 30 degrees and the pitch P is in the range of 5.1 to 5.6 times the subpixel width d. Accordingly, in some embodiments, the moiré effect can be mitigated or prevented.

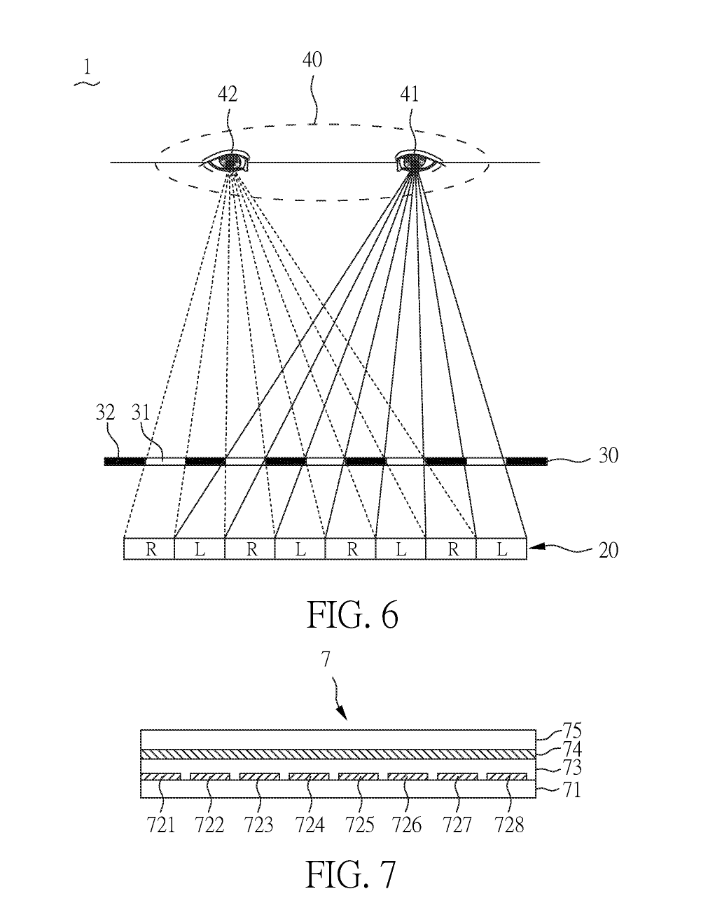

FIG. 6 is a schematic diagram showing the structure of the 3D display device (using parallax barrier) according to one embodiment of the present disclosure. In this embodiment, the 3D display device 1 mainly includes a display panel 20, as discussed in the above embodiments, and a plurality of elongate optical elements 30, arranged in front of the display panel 20.

In this embodiment, the elongate optical elements 30 are in the form of a parallax barrier, for example, a passive parallax barrier or a liquid crystal (LC) parallax barrier. Compared to the passive parallax barrier, by changing the optical characteristic of the liquid crystal, the LC parallax barrier can be switched to display the left-eye image and the right-eye image, so as to improve the resolution, or can be switched between 2D and 3D displays. The parallax barrier 30 has transparent portions 31 and opaque portions 32 with the same pitch and the same slant angle, wherein the range of the pitch and the range of the slant angle θ derived in the above embodiments are suitable for the parallax barrier in this embodiment.

FIG. 7 is a schematic diagram showing the structure of the LC parallax barrier according to one embodiment of the present disclosure. As shown in FIG. 7, the LC parallax barrier 7 includes a bottom insulant layer 71, a plurality of bottom electrodes 721 to 728, liquid crystal 73, a top electrode 74 and a top insulant layer 75, from bottom to top. For example, the parallax barrier can be formed by applying a voltage of 5V to the bottom electrodes 721, 722, 725, 726 for turning the corresponding part of the liquid crystal into the dark state, and by applying a voltage of OV to the bottom electrodes 723, 724, 727, 728 for turning the corresponding part of the liquid crystal into the bright state.

In this embodiment, the parallax barrier can be arranged at a location in front of the display panel. The parallax barrier can block the light in certain directions emitted from the display panel 20, thereby controlling the propagation of light.

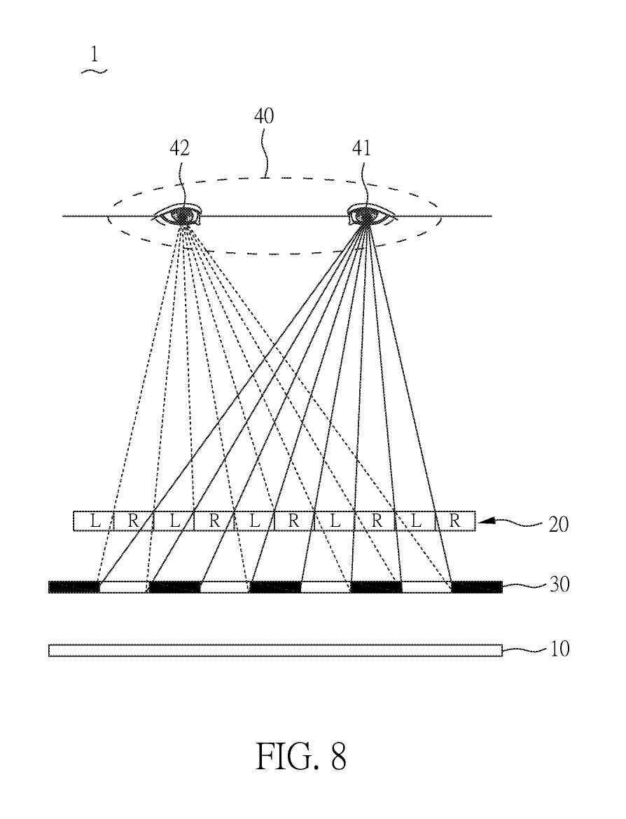

FIG. 8 is a schematic diagram showing the structure of the 3D display device according to one embodiment of the present disclosure. In this embodiment, the 3D display device 1 mainly includes a back light unit 10, a plurality of elongate optical elements 30 and a display panel 20, arranged in order. The elongate optical elements 30 are disposed behind the display panel 20.

In this embodiment, the elongate optical elements 30 are in the form of a parallax barrier. The parallax barrier can block the light in certain directions emitted from the back light unit 10, thereby controlling the propagation of light, wherein the ranges of the pitch and the slant angle θ derived in the above embodiments are suitable for the parallax barrier in this embodiment.

The right eye 42 of the user will see the right-eye image R and, although the lines of his/her right eye vision extend and fall on the subpixels displaying the left-eye image L, the subpixels are in dark state since the elongate optical elements 30 has blocked the backlight provided for the subpixels. The left eye 41 will has similar perception. Accordingly, a 3D image is generated.

In conclusion, the present disclosure provides a 3D display device, which uses slanted elongate optical elements. In some embodiments, Moiré effect can be mitigated or prevented.

Although the present disclosure has been explained in relation to some embodiments, it is to be understood that many other possible modifications and variations can be made without departing from the spirit and scope of the invention as hereinafter claimed.

What is claimed is:

1. A three-dimensional display device, comprising:
a display panel including a plurality of subpixels arranged in rows and columns, at least one of the subpixels having a subpixel width along a row direction of the rows of the subpixel; and
a plurality of elongate optical elements overlying the display panel, wherein at least one of the elongate optical elements is slanted at a slant angle to a column direction of the subpixel columns and has a pitch along the row direction, wherein the slant angle is 20 to 30 degrees.

2. The three-dimensional display device as claimed 1, wherein the slant angle is 24 to 30 degrees.

3. The three-dimensional display device as claimed 1, wherein the pitch has a pitch size of 4.5 to 5.9 times the subpixel width.

4. The three-dimensional display device as claimed 1, wherein the slant angle is 24 to 26 degrees.

5. The three-dimensional display device as claimed 3, wherein the pitch has a pitch size of 4.8 to 5.5 times the subpixel width.

6. The three-dimensional display device as claimed 1, wherein the slant angle is 28 to 30 degrees.

7. The three-dimensional display device as claimed 6, wherein the pitch has a pitch size of 5.1 to 5.6 times the subpixel width.

8. The three-dimensional display device as claimed 1, wherein the plurality of elongate optical elements extend along a longitudinal axis and parallel to each other.

9. The three-dimensional display device as claimed 1, wherein the plurality of elongate optical elements are a plurality of lenticular lenses or a plurality of gradient index (GRIN) lenses.

10. The three-dimensional display device as claimed 1, wherein the plurality of elongate optical elements is in the form of a parallax barrier.
